(19) United States
(12) Patent Application Publication
(10) Pub. No.: US 2008/0097756 A1
(43) Pub. Date: Apr. 24, 2008

(54) Method of and Apparatus for Analyzing Audio Content and Reproducing Only the Desired Audio Data

(75) Inventors: Alphonsus Anthonius Jozef De Lange, Eindhoven (NL); Jan Alexis Daniel Nesvadba, Eindhoven (NL); Igor Alexandrovich Nagorski, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,821

(22) PCT Filed: Nov. 2, 2005
(86) PCT No.: PCT/IB05/53574

§ 371 Date: May 8, 2007

(30) Foreign Application Priority Data
Nov. 8, 2004 (EP) 04105581.5
Dec. 16, 2004 (EP) 04106649.9

(51) Int. Cl. G10L 21/02

(52) U.S. Cl. 704/226

(57) ABSTRACT

A method of detecting and reproducing data comprises the steps of receiving a first signal comprising data, analyzing the data comprised by the first signal, categorizing the data into at least two categories of data defined as first category and second category; and reproducing the data when it is of the first category, and, when the data is of the second category, detecting whether it is in a predetermined sub-category of the second category, wherein (i) the data is reproduced when it is in the predetermined sub-category of the second category; (ii) the second signal is selected and data comprised in the second signal is reproduced when it is not in the predetermined sub-category of the second category.

The invention relates to a method of detecting and reproducing data, the method comprising the steps of receiving and analyzing a first signal comprising data.

The invention further relates to an apparatus for detecting and reproducing data.

The invention further relates to a computer program product, which is directly loadable into a memory of a programmable device.

An embodiment of such a method is known from US 2002/0072341, which document discloses a radio receiver including a voice-only detection mechanism that detects when the current radio station is transmitting mostly voice, and that changes the function of the receiver depending on whether or not the current radio station is transmitting mostly voice. The radio receiver mutes its audio output when the voice-only detection mechanism detects a voice broadcast. The audio output can be enabled once again when the voice-only detection mechanism detects a non-voice signal, thus allowing commercials and disk jockey talk to be automatically muted, with the volume returned to its previous level when music resumes.

However, the known method has the drawback that a listener will be inconvenienced or loses the reception of the program when a voice broadcast is received for a relatively longer period of time.

It is an object of the invention to provide a method of the type defined in the opening paragraph, an apparatus of the type defined in the second paragraph, and a computer program product of the type defined in the third paragraph, in which the drawback defined above is avoided.

In order to achieve the object defined above, a method of detecting and reproducing data comprises the steps of receiving a first signal comprising data, analyzing the data comprised by the first signal, categorizing the data into at least two categories of data defined as first category and second category; and reproducing the data when it is of the first category, and, when the data is of the second category, detecting whether it is in a predetermined sub-category of the second category, wherein (i) the data is reproduced when it is in the predetermined sub-category of the second category; (ii) switching to a second signal takes place when the data is not in the predetermined sub-category of the second category.

In order to achieve the object defined above, an apparatus for detecting and reproducing data comprises a receiving unit for receiving a first signal comprising data, an analyzing unit for analyzing the data comprised by the first signal, and a categorizing unit for categorizing the data into at least two categories of data defined as first category and second category; the apparatus being arranged to reproduce the data when it is detected to be of the first category, and, when the data is of the second category, to detect whether it is in a predetermined sub-category of the second category, wherein (i) the apparatus is arranged to reproduce the data when it is in the predetermined sub-category of the second category; (ii) the apparatus is arranged to switch to a second signal when the data is not in the predetermined sub-category of the second category.

In order to achieve the object defined above, a computer program product which is directly loadable into a memory of a programmable device comprises software code portions for performing the steps of the method as defined in any one of claims 1 to 7 when said product is run on said device.

It is an advantage of the invention if, for example, a user of a radio device can now listen to the desired and predetermined data of his preferred choice. This allows the user to experience continuous reception of music and data of the predetermined sub-category, such as traffic information, without manually tuning and searching for other broadcast channels on which the desired information is broadcasted.

In more detail, a music signal may represent, for example, data of a first category. The second category comprises two sub-categories, the first sub-category of which is a predetermined sub-category, such as traffic information. This predetermined sub-category relates to useful data that is still needed by the listener in the car.

The second sub-category relates to data that is not predetermined by the listener, such as voice-only non-traffic information. When data of the second sub-category is detected, a second signal is selected to reproduce data comprised in this second signal.

To explain the advantages of the invention, a short example of use will now be described. When the listener is in his car, he will still need the voice signal for traffic information. The present invention makes it possible for him to listen to both music and traffic information. When the received signal is not found to be the desired or predetermined signal, the listener will hear a reproduction of another signal.

It is further known from DE-3840707-A1 that the start of scanning for the next channel is delayed for a short period of time by routing the signal supplied by the speech recognition circuit to the scanning circuit via a timer unit so as to provide the adequate delay for bridging two consecutive pieces of music. This is to prevent gaps occurring in the transmission due to the speech recognition circuit detecting the announcement of the next piece of music. In this disclosure, there is still the drawback of muting the desired signal, such as traffic information. In the event that a prolonged transmission of the voice-only signal is received, the listener will again have to wait for an uncertain period of time before he receives the desired signal, such as music and data of the predetermined sub-category. The present invention has the advantage of overcoming or alleviating at least some of these drawbacks.

The measures as defined in claim 2 or 9 provide the advantage of reproducing off-air music signals pre-stored from another broadcast channel or music signals from an external or separate source, such as a CD player or another media player. The media player may be an MP3 player, a DVD player or other software realizations of similar devices.

The measures as defined in claim 3 or 10 provide the technical advantage of a relatively simpler and economical solution where a single tuner instead of two separate tuners is applied.

The measures as defined in claim 4 or 11 provide the advantage that the second signal is not limited to physical pre-recorded memory media, such as a CD.

The measures as defined in claim 5 or 12 provide the advantage that the second signal is not limited by the quality of off-air signals.

The measures as defined in claims 6 and 7 or claims 13 and 14, respectively, provide the advantage that they can be advantageously applied in the field of audio signal processing, as well as in the field of video processing.

The measures as defined in claim 15 provide the advantage that the predetermined sub-category of the second category can be automatically defined as traffic information when use in a car is detected.

The measures as defined in claim 16 provide the advantage that the predetermined sub-category of the second category can be automatically defined in dependence upon weather conditions.

The measures as defined in claim 17 provide the advantage that the invention can be applied to a telephone.

The advantages mentioned in connection with claims 1 to 7 also apply to the computer program product as defined in claim 18 and the record carrier as defined in claim 19.

These and further aspects of the invention are apparent from and will be elucidated by way of non-limiting example with reference to the embodiments described hereinafter.

In the drawings,

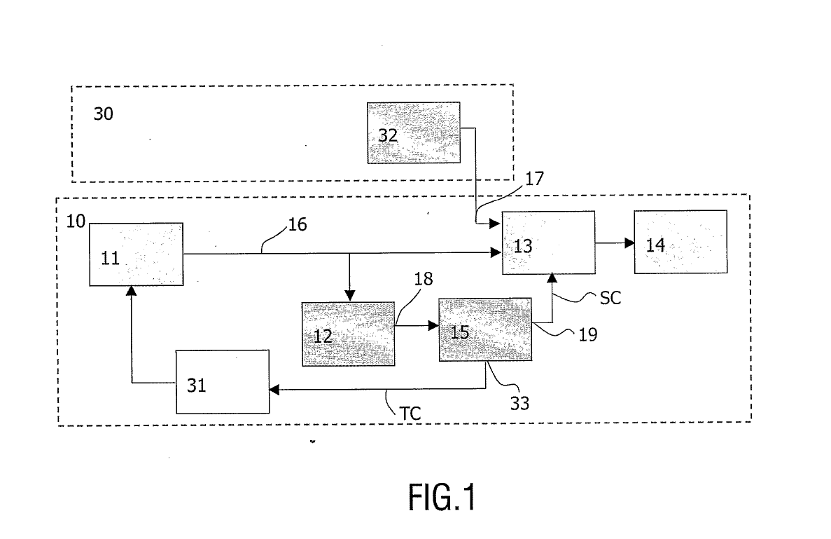

FIG. 1 is a block diagram of a first embodiment according to the invention.

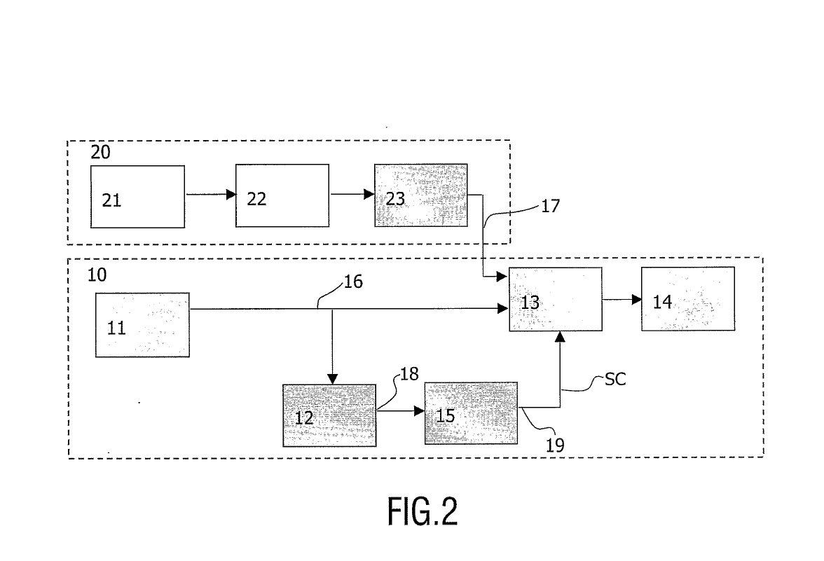

FIG. 2 is a block diagram of a second embodiment according to the invention.

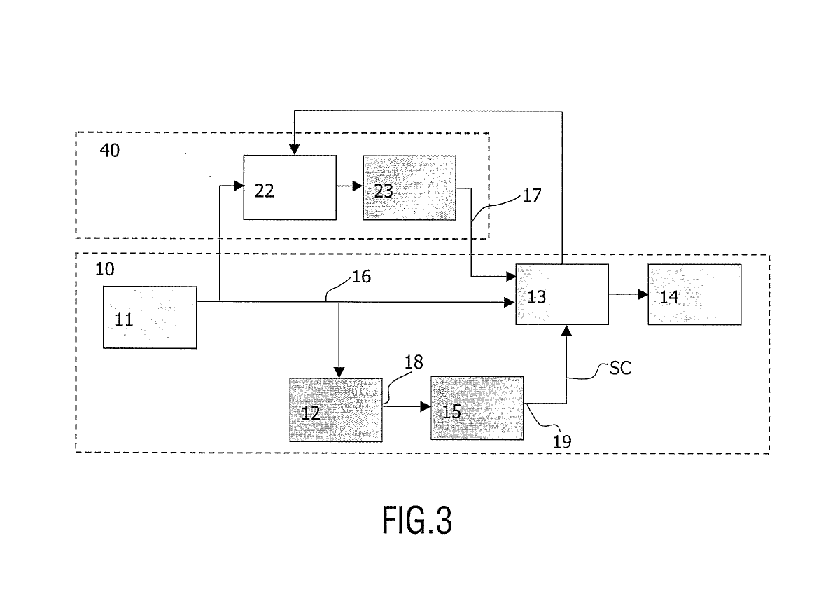

FIG. 3 is a block diagram of a third embodiment according to the invention.

The first embodiment in FIG. 1 shows a first data receiver 10 comprising a first tuner 11, a tuning control unit 31, a speech recognition and switch control unit 12, a time-out control unit 15, a switch 13, and an audio amplifier and loudspeaker 14, cooperating with a data source 30 comprising a memory unit 32. In the present case, the data source 30 is realized by a CD player connected to the first data receiver 10. The memory unit 32 is realized by a CD.

The first tuner 11, which in accordance with this embodiment is tuned to a first channel, supplies a first audio signal 16 at its output connected to both the switch 13 and the speech recognition and switch control unit 12. An output of the speech recognition and switch control unit 12 is connected to the input of the time-out control unit 15. The time-out control unit 15 has two outputs, wherein a first output 33 is connected to the input of the tuning control unit 31 and a second output 19 is connected to the switch 13.

The first audio signal 16 comprises data representing audio information, which can be categorized into two categories. The first category relates to music and the second category relates to a voice-only signal or speech. The second category can be further sub-categorized into a predetermined sub-category and a non-predetermined sub-category. The predetermined sub-category relates to useful information, such as traffic information, and the non-predetermined sub-category relates to non-useful information, such as commercials and dialogs.

In operation, the speech recognition and switch control unit 12 detects when the first audio signal 16 comprising data broadcast by a current station is of the non-predetermined sub-category, for example, a voice-only signal. In that case, the speech recognition and switch control unit 12 supplies an indication signal 18 indicating whether or not the music or data of the predetermined sub-category is received. This indication signal 18 is fed to the time-out control unit 15 upon detection of the first audio signal 16 not being music or data of the predetermined sub-category. The speech recognition and switch control unit 12 can recognize music and the voice-only signal with the means as disclosed in US 2002/0072341, and it can recognize data of the predetermined sub-category, such as traffic information, by detecting a pilot signal transmitted together with the data from the broadcasting station. In this respect, it is to be noted that the data of the predetermined sub-category may also represent business information or the like, and the identification of such data is subjected to an indication or pilot signal, which is transmitted or stored together with said data.

When the time-out control unit 15 receives the indication signal 18 from the speech recognition and switch control unit 12, it supplies two time-out signals, the first time-out signal representing a tuning control signal TC and the second time-out signal representing a switch control signal SC. The tuning control signal TC is applied to the tuning control unit 31 via the first output 33. The switch control signal SC is applied to the switch 13 via the second output 19. The first time-out signal has a first predetermined delay time, which is shorter than the second predetermined delay time of the second time-out signal. After the shorter, first predetermined delay time has elapsed and the first audio signal 16 does not comprise data of the predetermined sub-category, the first time-out signal of the time-out control unit 15 is sent to the tuning control unit 31 to start the first tuner 11 searching for a second channel or next channel until a music signal is detected by the speech recognition and switch control unit 12. When the first audio signal 16 representing music or data of the predetermined sub-category is received, the audio amplifier and loudspeaker 14 reproduces the music or this data.

When the music or data of the predetermined sub-category is not detected within the longer, second predetermined delay time, the second time-out signal of the time-out control unit 15 will cause the switch 13 to select a second audio signal 17 comprising pre-stored data from the memory unit 32, for example, pre-stored music content from the external or separate data source, which is the CD player. This second audio signal 17 is then reproduced by the audio amplifier and loudspeaker 14. This arrangement has the advantage that the listener will almost continuously receive reproduced music signals as well as useful information based on the data of the predetermined sub-category, without intervention by the listener.

The memory unit 32 may also be realized by another memory device which can be connected in, or cooperate with, the data source 30.

In a variant of this embodiment of the invention, the outputs of the time-out control unit 15 are interchanged. The shorter time-out signal is applied to switch 13 and the longer time-out signal is applied to the tuning control unit 31. In accordance with this embodiment, upon reception of a non-music signal or data the non-predetermined sub-category, the apparatus allows a short time-out before it switches to music playback from the memory unit 32. It is only after a predetermined longer time-out that the tuner starts tuning through the channels, while the speech recognition and switch control unit 12 checks and detects if the data received represents music or data of the predetermined sub-category.

Instead of an audio signal comprising music or data of the predetermined sub-category in a radio broadcast, the equivalent of a television broadcast is also applicable. In this case, music is equivalent to a desired TV program, while data of the predetermined sub-category is equivalent to useful data during commercial breaks, such as the announcement of coming programs, and an unwanted voice-only signal or data of a non-predetermined sub-category may be undesired commercial breaks, such as advertising clips.

In a second embodiment shown in FIG. 2, a two-tuner system is used which comprises the first data receiver 10 comprising the first tuner 11, which supplies the first audio signal 16 at its output, and a second data receiver 20. In contrast to the first embodiment shown in FIG. 1, the second data receiver 20 comprises a second tuner 21 supplying a second audio signal 17. In FIG. 2, all components which are identical to those in FIG. 1 are denoted by the same reference numerals and will not be further described in detail.

In operation, the first tuner 11 applies the first audio signal 16 to a speech recognition and switch control unit 12 and a switch 13. The second tuner 21 simultaneously searches for a music signal and its output is connected to the input of a speech recognition unit 22. When a music signal from the output of the second tuner 21 is detected by the speech recognition unit 22, it is stored as pre-stored data in a memory/buffering unit 23.

The search of predetermined data by the second tuner 21 may stop after a predetermined number of music songs is reached and only restarts the tuning and refreshes the pre-stored data that is utilized as the second audio signal 17 for reproducing music by the audio amplifier and loudspeaker 14. The predetermined number may be a fixed number, for example, 5 or 10 songs, or it may be any number preset by the listener.

In a variant of the second embodiment, it is noted that, when the pre-stored data is utilized as the second audio signal 17, the switch 13 may be arranged to send a first control signal to the second tuner 21 to start the channel tuning, and a second control signal to the speech recognition unit 22 to start detecting the music signal to be stored as pre-stored music in the memory/buffering unit 23, which is not shown in FIG. 2.

In contrast to the above-mentioned variant of the second embodiment, the second tuner 21 shown in FIG. 2 continuously searches for new data of the predetermined sub-category from different channels and stores them in the memory/buffering unit 23. When the memory/buffering unit 23 is full, the earliest pre-stored music may be dropped from the memory in a first-in-first-out manner. In this respect, it is noted that the second audio signal 17 can also be produced with the aid of pre-stored data which are e.g. provided from a CD player, or from a solid-state memory.

This second embodiment has the advantage that the listener will continuously receive the reproduction of music and data of the predetermined sub-category from off-air broadcasts or from a directly connected data source, without waiting for the first tuner 11 to search for the next channel when the first audio signal 16 does not comprise data of the predetermined sub-category. Since the music and data of the predetermined sub-category of tuner 21 is stored in memory/buffering unit 23 as well, there is a guarantee that broadcast music is always available to the listener or is predetermined by the user, although there may be a small time-shift due to switching. If the time-shift is zero, instantaneous switching to a different channel with a desired signal can be realized.

In a third embodiment shown in FIG. 3, the second tuner 21 of the second embodiment shown in FIG. 2 is omitted. In this embodiment, a first data receiver 10 comprises elements that are similar to those of the second embodiment shown in FIG. 2, except that the output of the first tuner 11 is connected to the speech recognition unit 22 of a third data receiver 40, which also comprises a memory/buffering unit 23. The output of the speech recognition unit 22 is connected to the memory/buffering unit 23.

In FIG. 3, all components that are identical to those in FIG. 1 or FIG. 2 are denoted by the same reference numerals and will not be further described.

The switch 13 has two outputs, a first output being connected to the audio amplifier and loudspeaker 14, and a second output being connected to the speech recognition unit 22 for controlling the detection of music signals received from the first tuner 11. The detected music signals will be used for refreshing the pre-stored data in the memory/buffering unit 23 whenever pre-stored data is utilized as second audio signal 17 for reproduction by the audio amplifier and loudspeaker 14. As long as no music or data of the predetermined sub-category is received by the first tuner 11, the pre-stored data is played back from memory/buffering unit 23. All music/data played back from the memory/buffering unit 23 through the switch 13 and the amplifier and loudspeaker 14 can be replaced by desired, new data/music. This is accomplished when the first tuner 11 receives desired data/music. As a result, the same songs previously received by the first tuner 11 are later repeated by replaying them from the memory/buffering unit 23. Consequently, the user can listen—on request—to data of the predetermined sub-category he has previously listened to. By choosing a sufficiently large capacity of the memory/buffering unit 23, this repetition will not be annoying to the listener.

While data is played back from memory/buffering unit 23, first tuner 11 continues to tune, in order to find a channel with music or data of the predetermined sub-category. When such a channel is found, the time-out control unit 15 is reset again, but now to a different time-out value, i.e. the minimal time that music or data of the predetermined sub-category reproduced from memory/buffering unit 23 or third data receiver 40 must go on. This time-out value can also be determined by the user. When this time has elapsed and there is still music or data of the predetermined sub-category received from first tuner 11, then the switch 13 selects the output of first tuner 11 again, i.e. the first audio signal 16, instead of second audio signal 17 from the output of memory/buffering unit 23. This mechanism is similar to the single tuner case, described above and shown in FIG. 1.

In a variant of the embodiment shown in FIG. 3, it is possible that the first audio signal 16 received from the first tuner 11 is continuously detected by the speech recognition unit 22, and a desired, new audio signal, such as music or data of the predetermined sub-category, is continuously pre-stored in the memory/buffering unit 23.

The third embodiment has the advantage that only a single tuner is needed and the listener will continuously receive the reproduction of desired music/data.

According to a further aspect of the invention, all of the above-mentioned embodiments may include a detector (not shown in this document) for detecting the use of the apparatus mounted in an automobile. Such a detector will set the priority to data of a particular predetermined sub-category, such as traffic information, so that the desired information will be reproduced by the audio amplifier and loudspeaker 14 when received by the first tuner 11 without any user interaction.

According to another aspect of the invention, a detector for detecting weather conditions may be provided. In such an embodiment, it is particularly advantageous to automatically set the priority for reproducing information to data of the predetermined sub-category, such as traffic information. In combination with the above-mentioned embodiment, this embodiment has the additional advantage when it is used in an automobile because the user will always be appropriately informed about traffic situations, which are typically of great importance when weather conditions are relatively poorbad. This can also be achieved by incorporating the measures of the invention in a mobile phone with a radio receiver.

A system can be mentioned as a further embodiment of the invention. The system comprises a programmable device operated by e.g. a service provider, and the device produces an electric signal representing data comprised either in a first signal or in a second signal. This data is transmitted via a network to another device of the system, in which device the data is made accessible to a user, e.g. visualized or processed for audible recognition. Consequently, the data is reproduced by transmitting data from a service provider-operated device to a user device, making the data accessible to the user.

The first audio signal 16 and the second audio signal 17 may be either of the analog or of the digital type. The first audio signal 16 and the second audio signal 17 may be received time-parallel on different channels, or time-sequentially in time slots.

Although the data source 30, the second data receiver 20, and the third data receiver 40 are depicted as separate units in the above-mentioned embodiments, they may be integrated in the first data receiver 10.

Elements of various embodiments can be combined without departing from the scope of the invention.

Furthermore, the invention may be embodied with a smaller number of components than in the embodiments described hereinbefore, wherein one component carries out multiple functions. The invention may also be embodied with more elements than described hereinbefore, wherein functions carried out by one component in the embodiment are distributed among multiple components.

It is to be noted that the protective scope of the invention is not limited to the embodiments described. Any reference sign placed between parentheses shall not be construed as limiting the claim. Use of the verb “comprise” and its conjugations does not exclude the presence of elements or steps other than those stated in the claims. Use of the indefinite article “a” or “an” preceding an element or step does not exclude the presence of a plurality of such elements or steps.

1. A method of detecting and reproducing data, the method comprising the steps of:
(A) receiving a first signal (16) comprising data,
(B) analyzing the data comprised by the first signal (16),
(C) categorizing the data into at least two categories of data defined as first category and second category; and
(D) reproducing the data when it is of the first category, and, when the data is of the second category, detecting whether it is in a predetermined sub-category of the second category, wherein
(i) the data is reproduced when said data is in the predetermined sub-category of the second category;
(ii) switching to a second signal (17) takes place when said data is not in the predetermined sub-category of the second category.

2. A method as claimed in claim 1, wherein the second signal (17) represents off-air data or pre-stored data.

3. A method as claimed in claim 2, wherein the second signal (17) represents off-air data provided via a first tuner (11).

4. A method as claimed in claim 2, wherein the off-air data originates from both a first tuner (11) and a second tuner (21).

5. A method as claimed in claim 2, wherein the pre-stored data is provided via a media player (32).

6. A method as claimed in claim 1, wherein the first signal (16) and the second signal (17) are audio signals.

7. A method as claimed in claim 1, wherein the first signal (16) and the second signal (17) are video signals.

8. An apparatus for detecting and reproducing data, the apparatus comprising:
(A) a receiving unit for receiving a first signal (16) comprising data,
(B) an analyzing unit for analyzing the data comprised by the first signal (16), and
(C) a categorizing unit for categorizing the data into at least two categories of data defined as first category and second category;
(D) the apparatus being arranged to reproduce the data when it is detected to be of the first category, and, when the data is of the second category, to detect whether it is in a predetermined sub-category of the second category, wherein
(i) the apparatus is arranged to reproduce the data when said data is in the predetermined sub-category of the second category;
(ii) the apparatus is arranged to switch to a second signal (17) when said data is not in the predetermined sub-category of the second category.

9. An apparatus as claimed in claim 8, arranged to process off-air data or pre-stored data represented by the second signal (17).

10. An apparatus as claimed in claim 9, comprising a first tuner (11) for receiving the second signal (17) that represents the off-air data.

11. An apparatus as claimed in claim 9, comprising a first tuner (11) and a second tuner (21), wherein the off-air data are receivable via both tuners (11, 21).

12. An apparatus as claimed in claim 9, arranged to process pre-stored data provided via a media player (32).

13. An apparatus as claimed in claim 8, arranged to process audio signals as the second signal (17).

14. An apparatus as claimed in claim 8, arranged to process video signals as the second signal (17).

15. An apparatus as claimed in claim 8, comprising a detector for detecting use in a car.

16. An apparatus as claimed in claim 8, comprising a detector for detecting weather conditions.

17. An apparatus as claimed in claim 8, wherein the apparatus is a telephone comprising a radio receiver.

18. A computer program product which is directly loadable into a memory of a programmable device, comprising software code portions for performing the steps of the method as claimed in claim 1 when said product is run on said device.

19. A record carrier carrying the computer program product as claimed in claim 18.
